(19) United States
(12) Patent Application Publication
(10) Pub. No.: US 2011/0214889 A1
(43) Pub. Date: Sep. 8, 2011

(54) Incense snuffer

(76) Inventors: Jason Bradley Sandberg, Leavenworth, WA (US); Matthew Lawrence Kozlowski, Kittitas, WA (US)

(21) Appl. No.: 12/660,836

(22) Filed: Mar. 5, 2010

(51) Int. Cl. A62C 3/00

(52) U.S. Cl. 169/48

(57) ABSTRACT

A device used to extinguish a burning stick of incense constructed of a hollow metal tube body and wire handle soldered together and oriented at a right angle to each other. The device is supported by a stick of incense when placed in a tray style incense holder. When the burning portion of the incense reaches the device, the air supply needed for combustion is diminished and the incense is extinguished.

### BACKGROUND OF INVENTION

1. Field of the Invention

The present invention relates to an incense extinguishing device.

2. Description of the Prior Art

There is one patent which relates to the present invention. Even though this innovation may be suitable for the specific individual purposes to which it addresses, however, it differs from the present invention.

U.S. Pat. No. 5,873,370 to Towle teaches a combined incense stick holder, extinguisher, and ash tray. Deficiencies in this design limit the use of the extinguisher exclusively to said device and is not transferable to other holders of prior art such as the present invention. The portion of the like invention which extinguishes the incense is also constructed in a different manner and of different materials of the present invention.

The present invention relates to a new and useful instrument used to extinguish a burning stick of incense automatically using a round, hollow, non-flammable tubing with a handle that is placed behind the burning portion of an incense stick. When the burning portion contacts the device the air flow needed for combustion is reduced and the incense is extinguished.

The invention is designed for use by people who prefer to burn smaller amounts of incense at one time. It benefits the user by allowing them to light a stick of incense, place the Incense Snuffer along the stick then leave it to burn out by itself. This allows the user to extinguish a burning stick of incense safely at any time. This can make burning incense in smaller rooms more enjoyable by releasing less smoke.

We have found that using the Incense Snuffer in conjunction with many horizontally oriented tray style incense holders of prior art provides the best configuration (FIG. 1). The tray holds the incense stick at an acute angle allowing the Incense Snuffer to be supported by it and perform as intended.

What is needed is a device that will allow a stick of incense to burn for a specific length of time followed by an extermination of the coal (burning portion) that is specifically chosen by the user. This would allow the user to relight and enjoy the incense again later.

### SUMMARY OF THE INVENTION

An object of the present invention is to provide an incense extinguishing device that avoids the disadvantages of the prior art.

Another object of the present invention is to provide an incense extinguishing tool that is simple and inexpensive to manufacture.

Still another object of the present invention is to provide an incense extinguishing tool that is simple to use.

Yet another object of the present invention is to provide an incense extinguishing tool that can extinguish a burning stick of incense in a controlled amount of time and only a portion of the stick is consumed.

The present invention is comprised of a bent wire handle soldered to a hollow metal tube. The present invention is supported by the incense stick at a position determined by the user to be the point of extermination. It has been found to be most effective when used in conjunction with a tray style incense holder of prior art, not considered to be part of the newly described invention.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawings (FIGS. 1-4).

### DESCRIPTION OF FIGURES

FIG. 1 is a front perspective view of the Incense Snuffer 1 which is placed on a stick of incense 3, such that it is supported by the stick which in turn is supported and held by the tray style incense holder 4 and allowing the burning portion 2 to be extinguished. This view depicts a typical setup and use of the present invention.

FIG. 2 is a front perspective view thereof; it identifies the main body 5 made of hollow metal tubing open on both ends upon which a handle 6, made of bent wire, is securely attached.

FIG. 3 is an elevation view of an Incense Snuffer; from left to right, is the side, front and top elevation views. Both right and left side views are mirror images of each other. Likewise, the front and rear views are mirror images of each other.

FIG. 4 is an elevation view showing a different handle variation. This is purely an example of how the handle can be easily changed by bending the wire into a different shape. This does not affect how the Incense Snuffer performs its intended use. What is shown, from left to right, is the side, front and top elevation views. Both right and left side views are mirror images of each other. Likewise, the front and rear views are mirror images of each other.

### DESCRIPTION OF THE REFERENCED NUMERALS

1 Incense Snuffer of the present invention
2 Burning portion of incense
3 Incense stick
4 Typical tray style incense holder not of present invention
5 Tubing Body
6 Handle

### DETAILED DESCRIPTION OF THE INVENTION

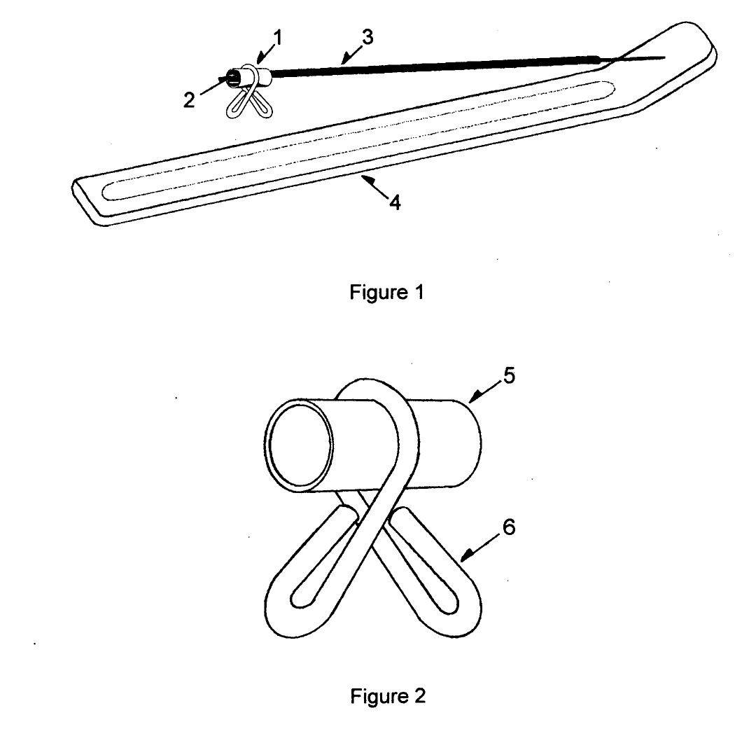

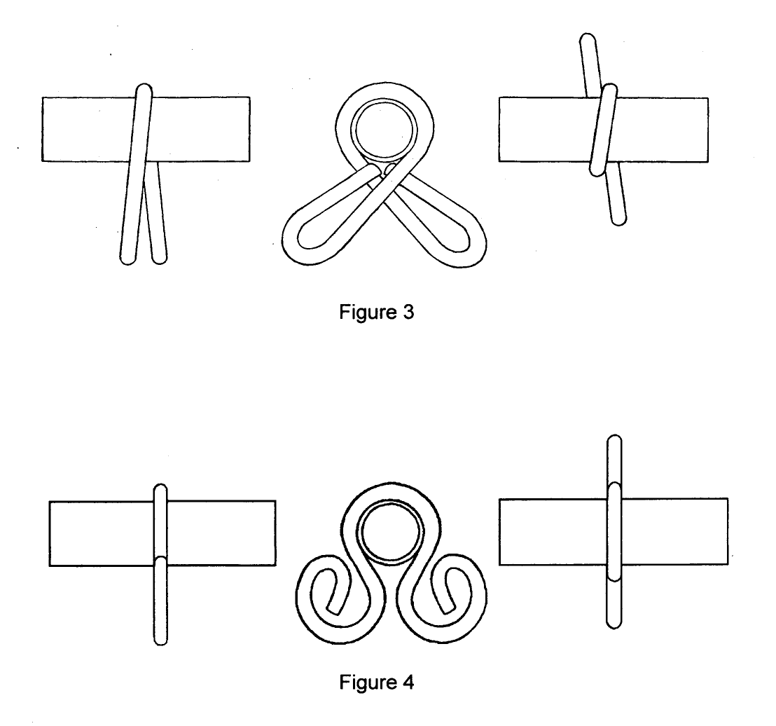

The Incense Snuffer 1 is a device used to extinguish a burning stick of incense 3 by interrupting the flow of air across the burning portion 2 of the incense. Using the Incense Snuffer 1 in conjunction with a tray style incense holder 4 or other such device intended to hold incense in a horizontal or acute angle position provides the optimum performance of the present invention (FIG. 1). The tray 4 holds the incense stick 3 in the previously mentioned position allowing the Incense Snuffer 1 to be supported by it.

The Incense Snuffer is constructed of two (2) separate pieces, a bent wire handle 6 attached to the tube body 5 (FIG. 2). The main body 5 is constructed of hollow metal tubing (brass, copper, or aluminum), the preferred heat and flame resistant material. Optimum dimensions of the tubing are between 0.5 cm (0.187 in.) and 1.0 cm (0.375 in.) in diameter and 1.0 cm (0.375 in.) to 2.5 cm (1 inch) in length. The handle portion 6 is made of 12 gauge wire that is bent around the tubing then fixed together with a solder or brazing type weld. The handle portion 6 of the Incense Snuffer 1 can have various styles and designs which do not affect the performance of the intended use of the device. See FIG. 6 for an example of a handle shape variation.

The materials, in various component combinations, can be sized to accommodate various incense sizes, all in accordance with the present invention, and as determined by the intended end use for the overall device.

The device is then cleaned and either colored with a patina solution and clear coated or left plain.

With respect to the above description then, it is to be realized that the optimum material and dimensional relationships for the parts of the Incense Snuffer, to include variations in size, materials, shape, and form, will occur to those skilled in the art upon review of the present disclosure, and all equivalent relationships to those illustrated in the drawings and described in the specification are intended to be encompassed by the present invention.

What is claimed as new and desired to be protected by Jason B. Sandberg is set forth in the appended claim:

1. A device for extinguishing a burning stick of incense either instantaneously or in a chosen amount of time determined by the placement of the device along the shaft of a horizontally oriented stick of incense. When the burning end of the incense stick approaches and contacts the Incense Snuffer device, the flow of air is diminished and the incense is extinguished.

2. The device of claim 1, wherein the main body is constructed of a hollow metal tubing material open on both ends.

3. The device of claim 1, wherein the handle is a metallic wire material fastened to the body of the device at a right angle and shaped to form a handle from which to hold the device.
